(19) United States
(12) Patent Application Publication
(10) Pub. No.: US 2016/0146584 A1
(43) Pub. Date: May 26, 2016

(54) Tracking Assembly

(71) Applicants: Kenneth Shepherd, Queen Creek, AZ (US); Kriquette Shepherd, Queen Creek, AZ (US)

(72) Inventors: Kenneth Shepherd, Queen Creek, AZ (US); Kriquette Shepherd, Queen Creek, AZ (US)

(21) Appl. No.: 14/551,586

(22) Filed: Nov. 24, 2014

(51) Int. Cl. F42B 12/38; F42B 6/02; G01S 19/19

(52) U.S. Cl. CPC F42B 12/385; G01S 19/19; F42B 6/02

(57) ABSTRACT

A tracking assembly for communicating a location of a projectile to a user after the projectile has been launched includes an arrow. A remote unit is coupled to the arrow. A processor is coupled to the remote unit. A transceiver is coupled to the remote unit. The transceiver is operationally coupled to the processor. The transceiver is in communication with an external electronic device carried by the user. A global positioning unit is coupled to the remote unit. The global positioning unit is operationally coupled to the processor. The global positioning unit determines a location of the arrow after the arrow is launched. The transceiver communicates the location of the arrow to the external electronic device. The arrow may be located after the arrow is launched.

### BACKGROUND OF THE DISCLOSURE

### Field of the Disclosure

The disclosure relates to tracking devices and more particularly pertains to a new tracking device for communicating a location of a projectile to a user after the projectile has been launched.

### SUMMARY OF THE DISCLOSURE

An embodiment of the disclosure meets the needs presented above by generally comprising an arrow. A remote unit is coupled to the arrow. A processor is coupled to the remote unit. A transceiver is coupled to the remote unit. The transceiver is operationally coupled to the processor. The transceiver is in communication with an external electronic device carried by the user. A global positioning unit is coupled to the remote unit. The global positioning unit is operationally coupled to the processor. The global positioning unit determines a location of the arrow after the arrow is launched. The transceiver communicates the location of the arrow to the external electronic device. The arrow may be located after the arrow is launched.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a right side view of a tracking assembly according to an embodiment of the disclosure.

FIG. 2 is a perspective view of an embodiment of the disclosure.

FIG. 3 is a cross sectional view taken along line 3-3 of FIG. 2 of an embodiment of the disclosure.

FIG. 4 is a schematic view of an embodiment of the disclosure.

FIG. 5 is an in-use view of an embodiment of the disclosure.

### DESCRIPTION OF THE PREFERRED EMBODIMENT

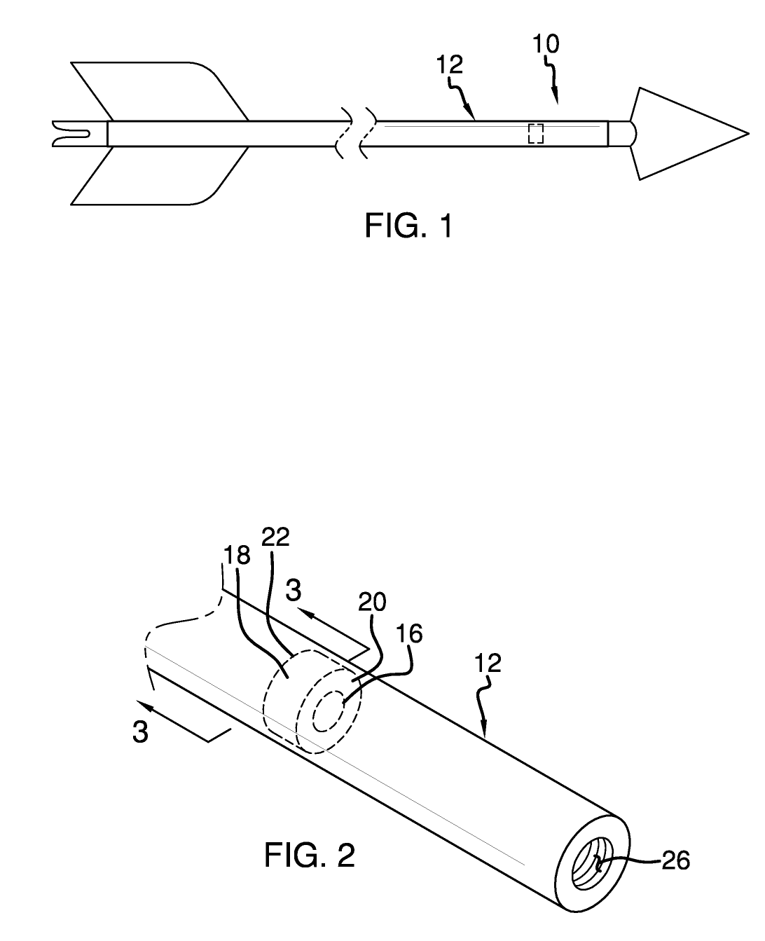

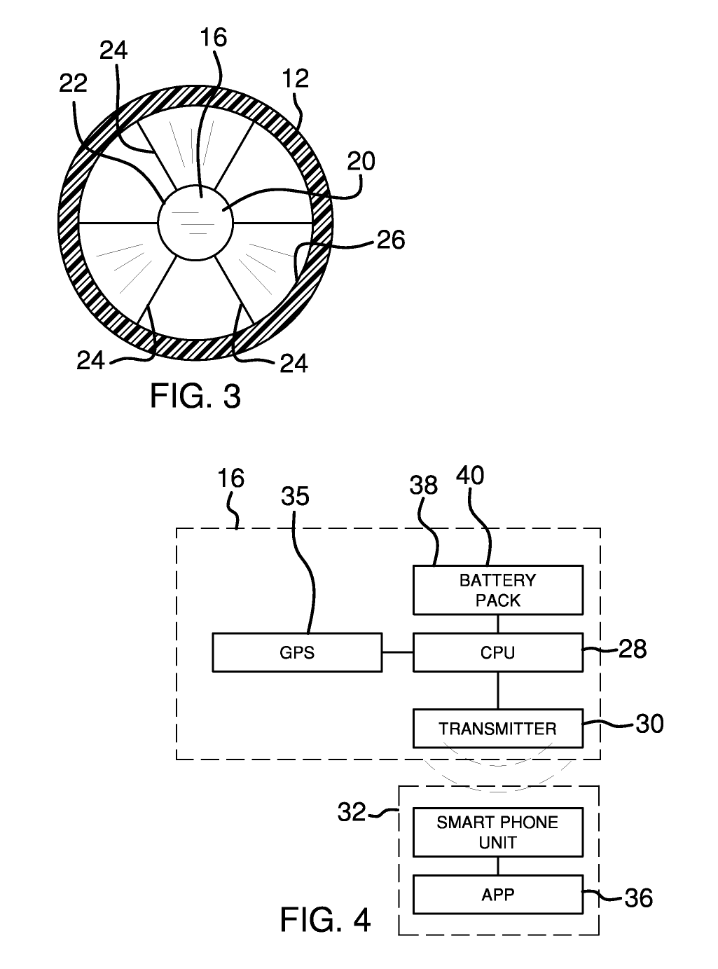

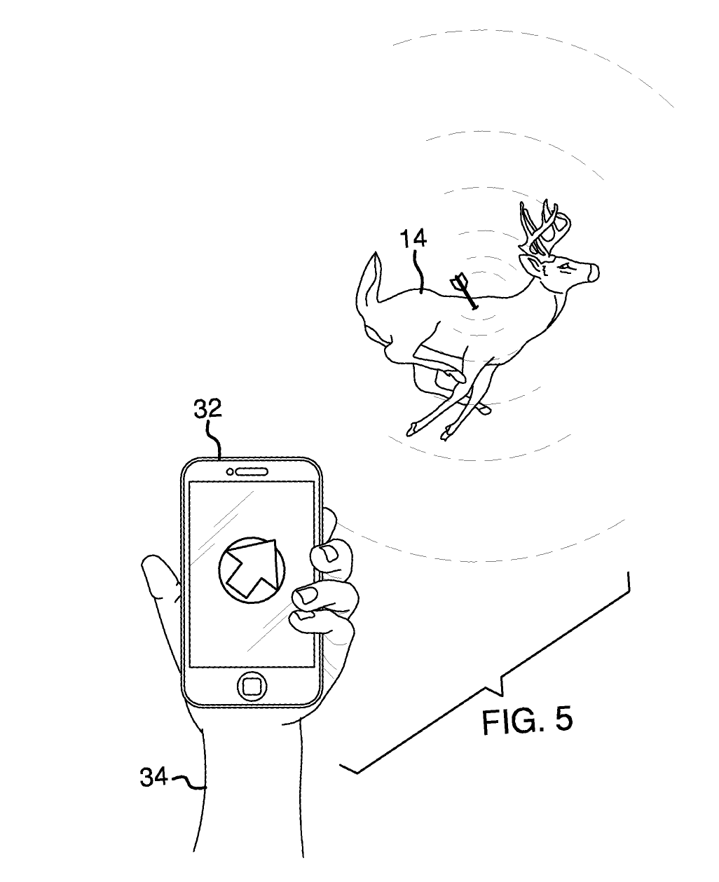

With reference now to the drawings, and in particular to FIGS. 1 through 5 thereof, a new tracking device embodying the principles and concepts of an embodiment of the disclosure and generally designated by the reference numeral 10 will be described.

As best illustrated in FIGS. 1 through 5, the tracking assembly 10 generally comprises an arrow 12. The arrow 12 is substantially hollow. Additionally, the arrow 12 may be a hunting arrow of any conventional design. The arrow 12 may be launched at game 14 for the purposes of hunting.

A remote unit 16 is provided. The remote unit 16 has an perimeter wall 18 extending between each of a front wall 20 and a back wall 22 of the remote unit 16. The remote unit 16 has a cylindrical shape. A plurality of fingers 24 is coupled to and extends outwardly from the perimeter wall 18 of the remote unit 16. The plurality of fingers 24 engages an inner surface 26 of the arrow 12 so the remote unit 16 is retained within the arrow 12. Additionally, the remote unit 16 is disabled if the remote unit 16 is removed from the arrow 12.

A processor 28 is coupled to the remote unit 16. The processor 28 may be an electronic processor of any conventional design. A transceiver 30 is coupled to the remote unit 16. The transceiver 30 is electrically coupled to the processor 28. Additionally, the transceiver 30 is in electromagnetic communication with an external electronic device 32 carried by a user 34.

The external electronic device 32 may be a smart phone of any conventional design. The transceiver 30 may have an operational range between 3 and 4 km. The transceiver 30 may additionally have an operational duration between 70 and 80 hours.

A global positioning unit 35 is coupled to the remote unit 16. The global positioning unit 35 is electrically coupled to the processor 28. Additionally, the global positioning unit 35 determines a location of the arrow 12 after the arrow 12 is launched. The transceiver 30 communicates the location of the arrow 12 to the external electronic device 32. The arrow 12 may be located after the arrow 12 is launched.

The external electronic device 32 contains a program 36. The program 36 allows the user 34 to track and locate the arrow 12 after the arrow 12 is launched. The program 36 may be a smart phone application. The program 36 may display the location of the arrow 12 with respect to the location of the user 34.

A power supply 38 is coupled to the remote unit 16. The power supply 38 is electrically coupled to the processor 28. The power supply 38 comprises at least one battery 40. Finally, the battery 40 may have an operational voltage between 1.5 VDC and 3 VDC.

In use, the user 34 launches the arrow 12 at the game 14. The user 34 utilizes the program 36 stored within the external electronic device 32 to determine a location of the arrow 12. The assembly 10 allows the user 34 to track and locate the game 14 after the arrow 12 strikes the game 14. Additionally, the assembly 10 allows the arrow 12 to be retrieved if the arrow 12 misses the game 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tracking assembly configured to communicate a location of a projectile to a user after the projectile has been launched, said assembly comprising:
an arrow;
a remote unit coupled to said arrow;
a processor coupled to said remote unit;
a transceiver coupled to said remote unit, said transceiver being operationally coupled to said processor, said transceiver being in communication with an external electronic device carried by the user; and
a global positioning unit coupled to said remote unit, said global positioning unit being operationally coupled to said processor, said global positioning unit determining a location of said arrow after said arrow is launched, said transceiver communicating the location of said arrow to the external electronic device such that said arrow is configured to be located after said arrow is launched.

2. The tracking assembly according to claim 1, further comprising said remote unit having an perimeter wall extending between each of a front wall and a back wall of said remote unit.

3. The tracking assembly according to claim 2, further comprising a plurality of fingers coupled to and extending outwardly from said perimeter wall of said remote unit.

4. The tracking assembly according to claim 3, further said arrow being substantially hollow, said plurality of fingers engaging an inner surface of said arrow such that said remote unit is retained within said arrow.

5. The tracking assembly according to claim 1, further comprising said transceiver being electrically coupled to said processor.

6. The tracking assembly according to claim 4, further comprising said transceiver being in electromagnetic communication with the external electronic device.

7. The tracking assembly according to claim 1, further comprising global positioning unit being electrically coupled to said processor.

8. The tracking assembly according to claim 1, further comprising a power supply coupled to said remote unit.

9. The tracking assembly according to claim 8, further comprising said power supply being electrically coupled to said processor.

10. The assembly according to claim 9, further comprising said power supply comprising at least one battery.

11. A tracking assembly configured to communicate a location of a projectile to a user after the projectile has been launched, said assembly comprising:
an arrow, said arrow being substantially hollow;
a remote unit having an perimeter wall extending between each of a front wall and a back wall of said remote unit;
a plurality of fingers coupled to and extending outwardly from said perimeter wall of said remote unit, said plurality of fingers engaging an inner surface of said arrow such that said remote unit is retained within said arrow;
a processor coupled to said remote unit;
a transceiver coupled to said remote unit, said transceiver being electrically coupled to said processor, said transceiver being in electromagnetic communication with an external electronic device carried by the user;
a global positioning unit coupled to said remote unit, said global positioning unit being electrically coupled to said processor, said global positioning unit determining a location of said arrow after said arrow is launched, said transceiver communicating the location of said arrow to the external electronic device such that said arrow is configured to be located after said arrow is launched; and
a power supply coupled to said remote unit, said power supply being electrically coupled to said processor, said power supply comprising at least one battery.
